(19) United States
(12) Patent Application Publication
(10) Pub. No.: US 2026/0158710 A1
(43) Pub. Date: Jun. 11, 2026

(54) MANUFACTURING METHOD OF A THERMOPLASTIC POLYURETHANE SHOE-SOLE COMPRISED HYDROPHOBIC NANO SILICA BY SUPERCRITICAL PHYSICAL FOAMING

(71) Applicants: Heedae PARK, Busan (KR); SAM BU FINE CHEMICAL CO., LTD., Gimhae-si (KR)

(72) Inventor: Heedae PARK, Busan (KR)

(21) Appl. No.: 19/305,760

(22) Filed: Aug. 21, 2025

(30) Foreign Application Priority Data
Dec. 9, 2024 (KR) 10-2024-0181314

(51) Int. Cl. B29C 43/00; A43B 13/04; B29B 9/12; B29B 9/16; B29C 43/02; B29K 75/00; B29K 105/04; B29K 509/02; B29L 31/50

(52) U.S. Cl. CPC B29C 43/003; A43B 13/04; B29B 9/12; B29B 9/16; B29C 43/02; B29C 44/02; B29C 45/0001; B29K 2075/00; B29K 2105/04; B29K 2509/02; B29K 2995/0093; B29L 2031/504

(57) ABSTRACT

This invention is related to a TPU shoe sole (midsole/insole) manufactured by supercritical physical foaming by incorporating hydrophobic nano-silica powder as a foaming nuclear agent to uniformly form microscopic foaming cells during the molding process, thereby achieving a soft touch, high elasticity, and comfortable fit, as well as excellent shape stability and durability, while also enabling lightweight products and reduced material costs.

### CROSS-REFERENCE TO RELATED APPLICATION

The present application claims priority under 35 U.S.C. § 119 to Korean Patent Application No. 10-2024-0181314 filed on Dec. 9, 2024 in the Korean Intellectual Property Office, the disclosures of which are incorporated herein by references in their entireties.

### TECHNICAL FIELD

### Field of the Technology

The present invention relates to a TPU shoe sole and a method for and manufacturing the TPU shoe sole composed of hydrophobic nano-silica by supercritical physical foaming, and more particularly, to a method for manufacturing a TPU shoe sole (midsole/insole) by supercritical physical foaming, wherein a hydrophobic nano-silica powder is included as a foaming nuclear agent to uniformly form fine foaming cells during the molding process of the TPU shoe sole (midsole/insole), resulting in a soft touch and high elasticity and comfortable wearing comfort, The present invention relates to a method for manufacturing a TPU shoe sole comprising hydrophobic nano-silica by supercritical physical foaming, which has excellent shape stability and durability and can realize light weight and material cost reduction.

### Background of the Invention

In general, shoes, sneakers, hiking boots, and other footwear consist of an upper leather that forms the exterior, an outsole that contacts the ground, a midsole that is installed on top of the outsole, and an insole that contacts the sole of the foot. The midsole and the insole are added with various functions based on the research that the health of the foot is a very important factor for the human body.

The midsole is installed in the middle layer of the shoe and is formed into a structure that enables comfortable walking by absorbing the weight of the human body's load on the shoe as elastic energy during walking, and The insole, located on the upper part of the midsole, is molded into an ergonomic structure that can effectively absorb and disperse the impact on the sole of the foot, and materials that absorb sweat and have antibacterial and deodorizing properties are often used. Recently, considering the diversity of materials, technologies related to midsoles and insoles with high elasticity are being developed.

These midsoles and insoles are usually manufactured in the form of foam sheets by foaming polyurethane (PU), ethylene-vinyl acetate (EVA), polyethylene (PE), polypropylene (PP), latex, and Pebax, and are applied as various types of shoe sole materials.

In particular, thermoplastic polyurethane (TPU) resin is a non-toxic material with excellent elasticity and durability, and is an eco-friendly material with excellent recyclability because it can be plasticized by heat. In the case of foamed molded products made by foaming it, it maintains excellent performance while having the advantages of low density, insulation, soundproofing, and cushioning, so it is widely used in the fields of shoes, automobiles, and electrical and electronics, and can be applied to an even wider range of fields.

And the foaming methods of the TPU resin mentioned above include chemical foaming and physical foaming. Chemical foaming is a foaming method that uses foaming agents such as azo-based foaming agents, chlorofluorocarbon (CFC), and low-boiling-point solvents. Physical foaming is a method that creates bubbles by dissolving liquefied gas or supercritical fluid in the resin. Since physical foaming does not use chemical foaming agents or freon, it does not emit pollutants, so it has low environmental hazards and can create recyclable foam molded products.

For example, physical foaming using supercritical carbon dioxide is a very effective and environmentally friendly method for forming foam particles or molded articles without residues. The combination of this foaming step and the subsequent molding step is commercially practiced mainly for thermoplastic resins having a glass transition temperature (Tg) below 0° C., including thermoplastic polyurethane, ethylene vinyl acetate copolymer, polypropylene, and polyester elastomers. Conventional shoe soles have not been able to overcome the high material cost and the limitations of the physical properties of the product even when using chemical or physical foaming agents, and thus have an overall heavy and hard feel, which does not keep up with the development trend toward lightweighting.

The supercritical fluid (CO₂, N₂) for the above physical foaming is a fluid that has the solubility of a liquid and the diffusivity of a gas under high temperature and high pressure conditions, and has the advantage of being able to precisely control the injection amount and dissolve a large amount of blowing agent in the resin. However, in the case of physical foaming using a supercritical fluid, there are common problems such as low foaming where the initial target specific gravity reduction is not achieved, as well as problems such as uneven foaming cells and pinholes forming on the product surface.

Looking at an related art for manufacturing TPU foam using the supercritical physical foaming method as described above, Korean Patent No. 10-1609355, which comprises a step S100 of manufacturing a midsole by supercritical foaming injection of TPU resin and then cutting it; and a step S200 of manufacturing an integral shoe sole by inserting the midsole manufactured through step S100 into an outer sole mold and then injecting a specific ‘dynamically cross-linking thermoplastic elastomer composition’ into the outer sole mold; wherein step S100 is characterized by using a supercritical foaming injection molding machine to supercritical foam-mold TPU resin, and injecting it as a foam having a specific gravity of 0.3 to 0.5, and relates to a method for manufacturing an integral shoe sole having excellent lightweight and cushioning properties.

In addition, Korean Patent No. 10-1856884 discloses A method for making a low density foamed article, comprising: combining in an extruder a molten polymer selected from the group consisting of thermoplastic polyurethane elastomers and thermoplastic ethylene-vinyl acetate copolymers with (a) a physical or chemical blowing agent other than a supercritical fluid and (b) a supercritical fluid, wherein the blowing agent (a) is present in an amount up to about 15 wt % based on polymer weight and the supercritical fluid comprises one of about 0.1 to about 5 weight percent of supercritical CO₂ based on polymer weight or about 0.1 to about 4 weight percent of supercritical N₂ based on polymer weight, to form a mixture and injection molding the mixture in a mold to form the low density foamed article, wherein the mold comprises a porous tool.

In addition, the rigid polyurethane foam in Korean Patent No. 10-1867064 is manufactured by foaming and curing using a mixed polyether polyol base of 1 to 50 parts by weight of a triethanolamine-based polyether polyol per 100 parts by weight of a polyether-based polyol, an amine-based catalyst, a curing agent including polymerizable MDI having an NCO functional group number of 2.5 to 2.9, and a mixed blowing agent of HFCs and supercritical carbon dioxide, wherein the mixed blowing agent is used in an amount of 1 to 40 parts by weight per 100 parts by weight of the polyol base, and carbon dioxide in the mixed blowing agent is contained in an amount of 1 to 30 parts by weight per 100 parts by weight of HFCs.

And, Korean Patent No. 10-2397310 proposes a method for manufacturing a highly expanded polyurethane foam without using a solvent, including an injection step of introducing a polyurethane raw material into a reactor; a reaction step of reacting the polyurethane raw material by applying heat and pressure within the reactor; a constant temperature and constant pressure step of maintaining the temperature and pressure within the reactor constant; and a step of foaming and curing the polyurethane raw material, characterized in that in the reaction step, carbon dioxide is injected into the reactor and heat and pressure are applied such that the density of the carbon dioxide becomes 0.127 to 0.200 g/cm³.

Meanwhile, in the present invention, by including hydrophobic nano-silica powder as a foaming nucleus during the TPU sole (midsole/insole) molding process by supercritical physical foaming, fine foam cells are uniformly formed throughout, thereby improving the size deviation of foam pellets as well as the density difference by section, thereby improving the quality and productivity of the product, and a method for manufacturing a TPU sole containing hydrophobic nano-silica by supercritical physical foaming has been developed.

### RELATED DOCUMENTS

### Patent Documents

(Patent Document 0001) Republic of Korea Patent Publication No. 10-1609355 (Publication Date: Apr. 5, 2016)
(Patent Document 0002) Republic of Korea Patent Publication No. 10-1856884 (Publication Date: May 10, 2018)
(Patent Document 0003) Republic of Korea Patent Publication No. 10-1867064 (Publication Date: Jun. 14, 2018)
(Patent Document 0004) Republic of Korea Patent Publication No. 10-2397310 (Publication Date: May 12, 2022)

### INVENTION DISCLOSURE

### Problems to be Solved

The purpose of the present invention is to provide a method for manufacturing a TPU shoe sole containing hydrophobic nano-silica by supercritical physical foaming, which comprises including hydrophobic nano-silica powder as a foaming nucleus during a TPU shoe sole (midsole/insole) molding process by supercritical physical foaming, so that fine foam cells are uniformly formed throughout, thereby producing a highly foamed product without size deviation of foam pellets or density difference by section, and furthermore, which has a soft touch and a comfortable fit with high elasticity, as well as good dimensional stability and excellent durability, and which enables weight reduction of the product and reduction of material costs.

Another purpose of the present invention is to include hydrophobic nano-silica powder as a foaming nucleus and to prepare TPU soles (midsole/insole) by an autoclave process with a supercritical physical foaming process to ensure uniformity of foam quality and molding precision at the same time, and to provide a manufacturing method for TPU soles mixed with hydrophobic nano-silica by supercritical physical foaming that can control the foaming rate and secure physical properties in the manufacture of TPU molded bodies of high hardness (e.g., 90 A or more).

### Means for Solving the Problems

A method for manufacturing a TPU shoe sole mixing with hydrophobic nano-silica by supercritical physical foaming according to a first embodiment of the present invention includes: the steps of manufacturing a TPU shoe sole using a thermoplastic polyurethane resin composed of a polyol, an isocyanate, and a chain extender as raw materials, wherein the thermoplastic polyurethane resin includes hydrophobic nano-silica powder having a primary particle size of 1 to 100 nm as a foaming nuclear agent in an amount of 0.1 to 5 parts per hundred resin (phr), wherein the hydrophobic nano-silica powder forms nano-silica aggregates having an average size of 100 to 1,200 nm in the TPU resin; and injecting a supercritical fluid into the TPU resin at a temperature of 120 to 180° C. to form foam pellets having a specific gravity of 0.05 to 0.25; and compressing molding the foam pellets.

A method for manufacturing a TPU shoe sole incorporating hydrophobic nano-silica by supercritical physical foaming according to a second embodiment of the present invention, wherein the TPU shoe sole is manufactured using a TPU resin comprising a polyol, an isocyanate and a chain extender, wherein the TPU resin containing a hydrophobic nano-silica powder having a primary particle size of 1 to 100 nm as a foaming nuclear agent in a range of 0.1 to 5 Parts per Hundred Resin (phr), wherein the hydrophobic nano-silica powder forms nano-silica aggregates having an average size of 100 to 1200 nm in the thermoplastic polyurethane resin, and the TPU resin is injection molded to a specific gravity in a range of 0.05 to 0.25 by injecting a supercritical fluid at a temperature of 160 to 220° C. into the TPU resin.

A method for manufacturing a TPU shoe sole containing hydrophobic nano-silica produced by supercritical physical foaming according to the third embodiment of the present invention comprises manufacturing a TPU shoe sole using a TPU resin composed of polyol, isocyanate, and chain extender, wherein the TPU resin includes hydrophobic nano-silica powder with primary particle sizes of 1 to 100 nm as a foaming agent at a specific gravity in a range of 0.1 to 5 phr, wherein the hydrophobic nano-silica powder forms nano-silica aggregates with an average size of 100 to 1,200 nm in the TPU resin, the method comprising: injection molding the TPU resin to prepare a preform using a conventional injection molding; and injecting supercritical fluid to the preform at a temperature range of 120 to 220° C. to produce a foamed preform with a specific gravity in a range of 0.05 to 0.15 by applying a supercritical physical foaming process using an autoclave process, and finally compress-molding the foamed preform to produce a TPU shoe sole with a specific gravity in a range of 0.07 to 0.17.

Here, the hydrophobic nano-silica powder may include at least one hydrophobic functional group selected from an alkyl group, a dimethyl group, a trimethyl group, a dimethyl siloxane group, and a methacryl group on the surface of the nano-silica particles, and the supercritical fluid is injected with at least one gas selected from carbon dioxide (CO₂) and nitrogen (N₂) at a temperature and pressure higher than the critical point, and the product manufactured by compression molding or injection molding is at least one of a shoe insole and a midsole.

At this time, the critical point of the carbon dioxide is 31° C. and 7.38 MPa, and the critical point of nitrogen is preferably −146.9° C. and 3.39 MPa. Under the conditions where these temperatures and pressures are simultaneously satisfied, a supercritical state is reached where the gas simultaneously has properties similar to those of a liquid.

### Effects of the Invention

The TPU shoe sole comprising hydrophobic nano-silica by supercritical physical foaming manufactured by the manufacturing method according to aspect(s) of the present invention may include a predetermined amount of hydrophobic nano-silica powder as a foaming nuclear agent during the TPU shoe sole (midsole/outsole) molding process, so that fine foam cells are uniformly formed throughout, and thus there is almost no size deviation of the foam pellets or difference in density by section, and in addition to a soft feel and a comfortable fit with high elasticity, it has excellent shape stability and durability, and can realize the effect of realizing product weight reduction and material cost reduction.

In addition, the present invention manufactures a TPU shoe sole containing hydrophobic nano-silica by supercritical physical foaming using an autoclave process, thereby reducing the defect rate (e.g., the defect rate reaching 20% to 40%) caused by the shape stability of the final product due to the foaming rate deviation and shrinkage rate of the conventional autoclave process, and simultaneously securing the uniformity of foaming quality and molding precision, and in particular, has a very advantageous advantage in controlling the foaming rate and securing physical properties when manufacturing a TPU molded body having high hardness (e.g., 90 A or higher).

### BRIEF DESCRIPTION OF THE DRAWINGS

FIG. 1 is a flow chart showing a method for manufacturing a TPU shoe sole mixed with hydrophobic nano-silica by supercritical physical foaming according to a preferred first embodiment of the present invention.

FIG. 2 is a flow chart showing a method for manufacturing a TPU shoe sole mixed with hydrophobic nano-silica by supercritical physical foaming according to a preferred second embodiment of the present invention.

FIG. 3 is a flow chart showing a method for manufacturing a TPU shoe sole mixed with hydrophobic nano-silica by supercritical physical foaming using an autoclave process according to a preferred third embodiment of the present invention.

FIG. 4a is a drawing showing a photograph of the surface of a TPU resin mixed with hydrophobic nano-silica according to the present invention measured at a magnification of 50,000 times using SEM.

FIG. 4b is a drawing showing a photograph of the surface of a TPU resin mixed with hydrophobic nano-silica according to the present invention measured at a magnification of 100,000 times using SEM.

FIG. 5a is a drawing showing an actual photograph of TPU foam pellets (containing 1 phr of hydrophobic nano silica) manufactured by the first embodiment of the present invention.

FIG. 5b is a drawing showing an actual photograph of TPU foam pellets in which hydrophobic nano silica is not mixed.

### DETAILED EMBODIMENTS FOR IMPLEMENTING THE INVENTION

Hereinafter, a method for manufacturing a TPU shoe sole containing hydrophobic nano-silica by supercritical physical foaming according to the present invention will be described. However, this is only intended to be an example to enable a person having ordinary knowledge in the technical field to which the present invention pertains to easily carry out the invention, and does not mean that the technical idea and scope of the present invention are limited thereby. It will be understood that, although the terms “first,” “second,” “third” etc. may be used herein to describe various embodiments, these terms should not be limited by these terms. These terms are only used to distinguish one embodiment from other embodiments.

In general, polyurethane resin is a resin formed based on a urethane bond formed by the reaction of an isocyanate group (—NCO) and a hydroxyl group (—OH) in a polymer, and its raw materials include polyol, isocyanate, chain extender, etc. By adjusting the ratio of the soft segment and hard segment that make up the polyurethane, it is possible to design various molecular weight blends, from elastic products like rubber to hard products.

The characteristics of this polyurethane resin are that it has excellent film strength and adhesive strength, so it is possible to manufacture a thin coating film, and the elasticity of the coating film is rich, so it can be manufactured into a porous film or sheet that is soft to the touch, so it can provide moisture permeability and ventilation, and it has excellent cold resistance, and because it is processed without using a plasticizer, there are few workability problems caused by the plasticizer.

The above polyol is an active hydrogen compound used to manufacture polyurethane by reacting with isocyanate, and refers to one having two or more active hydrogen groups such as a hydroxyl group, a carboxyl group, or an amine group in the molecule. Depending on the molecular structure, molecular weight, functionality, and OH-value, the use of various types directly affects the properties of polyurethane.

For example, polyurethane using polyester polyol has higher tensile strength, hardness and elongation than polyurethane using polyether polyol, and has excellent flame retardancy, as well as excellent chemical resistance and drug resistance, so it is resistant to oxidation and has excellent adhesion to various fabrics woven with polyester or nylon, but its disadvantage is that it has poor water resistance due to its tendency to hydrolyze. However, polyurethane using polyether polyol has excellent elasticity and can be used in high temperature and humid environments, and shows excellent durability against acids and alkalis, so it is desirable to use them alone or in combination depending on the intended use.

The above polyurethane (PU) resin is manufactured by mixing polyether, which is made by polymerizing ethylene oxide, with diisocyanate to produce polyurethane. Urethane is a mixed amide-ester that is created when an alcohol group reacts with isocyanate. When a triol is used instead of a diol, cross-linking occurs to produce a thermosetting polyurethane.

Accordingly, the method for manufacturing a TPU shoe sole containing hydrophobic nanosilica produced by supercritical physical foaming according to the first embodiment of the present invention using a TPU resin composed of polyol, isocyanate, and chain extender as raw materials to manufacture the TPU shoe sole, wherein the TPU resin contains hydrophobic nano-silica with primary particle sizes of 1 to 100 nm as a foaming agent at a specific gravity of 0.1 to 5 parts per hundred resin (phr), the hydrophobic nano-silica forms nano-silica aggregates with an average size of 100 to 1,200 nm within the thermoplastic polyurethane resin, and the TPU resin is injected with a supercritical fluid at a temperature of 120 to 180° C. to produce a foamed pellet with a density of 0.05 to 0.25, and the foamed pellet is then compression molded.

The thermoplastic polyurethane (TPU) resin used in the present invention is obtained by polymerizing raw materials such as polyol and isocyanate and a low molecular weight glycol as a chain extender. Examples of the polyol used here may include polyester polyol, polyether polyol, and polycaprolactone, examples of the isocyanate include aromatic isocyanate, aliphatic isocyanate, and the like, and examples of the low molecular weight glycol may include 1,4-butanediol.

In addition, the supercritical physical foaming according to aspect(s) of the present invention is a technology for manufacturing foam pellets having a specific gravity of 0.05 to 0.25 by injecting a supercritical fluid as a foaming agent, and means injecting at least one gas selected from the group consisting of carbon dioxide (CO₂) and nitrogen (N₂), which are the supercritical fluids, at a temperature and pressure higher than the critical point.

The above supercritical fluid refers to a fluid in which the temperature and pressure of a substance exceed the critical point and the state in which it is indistinguishable from a liquid and a gas is reached, and its density and solubility are similar to those of a liquid, while its viscosity, diffusivity, and thermal conductivity are similar to those of a gas.

In fact, no gas on Earth can become a liquid no matter how much it is compressed at room temperature. This is because the critical temperatures of nitrogen (N₂) and oxygen (O₂) are lower than room temperature. If nitrogen and oxygen are not cooled and only compressed at room temperature, they will become supercritical fluids and not liquids. For reference, the critical point of nitrogen is −146.9° C. and 3.39 MPa, the critical point of oxygen is −118.6° C. and 5.05 MPa, carbon dioxide has a critical point of 31° C. and 7.38 Mpa, and water has a critical point of 374° C. and 22.1 Mpa. Supercritical carbon dioxide refers to carbon dioxide that has a high density like a liquid but low viscosity like a gas under specific temperature and pressure conditions.

The mixing amount of the supercritical fluid as the above-mentioned foaming agent is determined by considering the apparent density of the intended foamed pellets or product, the type of TPU resin, etc., but usually, it is possible to inject the foaming agent in a range of 0.1 to 30 parts by weight per 100 parts by weight of the TPU resin.

In the foaming molding method using the supercritical fluid as described above, in order to obtain foamed polyurethane with an excellent appearance without pinholes on the surface, the control of the supercritical fluid after the mixed polyurethane raw materials are injected into the mold is the key, and for this control, it is important to adjust the viscoelasticity of the raw materials.

A specific method for controlling this viscoelasticity is to control the molecular structure of the thermoplastic polyurethane resin. For example, the melt strength can be improved by increasing the molecular weight of the resin, broadening the molecular weight distribution (MWD), or introducing a long-chain branch structure to increase the entanglement between chains in the molten state. Then there is the use of specific additives, like as in the present invention. That is, nano-silica is added to act as a physical cross-linking point within the molten polymer matrix to increase the overall melted viscosity and elasticity to maximize the stability of the bubbles according to an aspect(s) of the present invention.

In addition to the development of a process control technology for injecting the supercritical fluid as described above, by incorporating hydrophobic nano-silica powder with primary particle sizes ranging from 1 to 100 nm as a foaming nuclear agent for thermoplastic polyurethane resin in a range of 0.1 to 5 parts per hundred resin (phr), thereby uniformly forming fine foam cells, thereby controlling the viscoelasticity of the TPU resin, thereby manufacturing a lightweight TPU shoe sole (midsole/insole) having a specific gravity of 0.05 to 0.25 according to an aspect of the present invention.

The above hydrophobic nano-silica powder is dispersed into a particle size having the most suitable mixing properties based on the fact that it has excellent physical and chemical compatibility with TPU resin, and thus the product quality, including formability, homogeneity, elasticity, and durability, is very good.

The above-mentioned foaming nuclear agent (FNA) plays a role in creating small cells by dividing the gas around the nuclear agent during the melting and mixing process of thermoplastic polyurethane resin and supercritical fluid (gas). Since these nuclear agents are essential additives for high-expanding gas foaming, their type and function determine the physical properties of the foamed product, such as a size, elongation, strength, and appearance of the foamed cell. Therefore, it is essential to select them appropriately, taking into account the purposes and quality of the foamed product.

The content of the hydrophobic nano-silica powder used in the present invention can be adjusted within a specific range depending on the hardness and density of the desired molded body. However, if the content of the hydrophobic nano-silica powder is less than 0.1 phr compared to the TPU resin, the uniform foam formation effect is minimal, and it is difficult to expect shape stability and increased elasticity of the product. In addition, if the content of the hydrophobic nano-silica powder exceeds 5 phr, there are restrictions on the process conditions for uniformly forming the hardness of the molded body, making it difficult to manufacture a foam molded body having the desired elasticity (cushioning).

For reference, the specific gravity of conventional EVA foam is 0.18 to 0.22, that of PU foam is 0.25 to 0.38, and Pebax (polyether block amide) foam has a density of approximately 0.13 to 0.17. Considering this, the TPU foam according to aspect(s) of the present invention, which is produced by supercritical physical foaming and contains hydrophobic nano-silica, can be lighter and have better properties than EVA foam or PU foam. Despite having similar density properties to Pebax foam, it offers superior cost competitiveness and enables the formation of a broader range of low-density TPU foams, thereby allowing the production of various types of highly foamed shoe soles.

As described above, when hydrophobic functional groups are introduced onto the surface of nano-silica particles contained in TPU resin as a foaming nuclear agent, the dispersibility of nano-silica is improved, and the hydrophobicity of the functional groups enhances the water resistance and tensile strength of the manufactured shoe soles, thereby improving properties such as moldability. The hydrophobic groups that can be introduced onto the surface of the nano-silica particles include alkyl groups, dimethyl groups, trimethyl groups, dimethyl siloxane groups, and methacryl groups. For example, the nano-silica particles included in the thermoplastic polyurethane resin of the present invention are obtained by adjusting the temperature and pressure in the fumed silica manufacturing process and treating the nano-silica with an organ silane compound, thereby incorporating dimethyl groups on the surface of the nano-silica particles.

The above-mentioned hydrophobic functional groups introduced into the nano-silica particles should preferably have an OH group density of 1.0 OH/nm³ or less. The density of the OH group can be measured by a known method, such as measuring the molar absorbance, ε, of the OH stretching oscillation band in the organosilanol group at 3750 cm⁻¹ using IR spectroscopy by reacting nano-silica particles and lithium aluminium hydrohydride with hydrophobic actuators.

According to aspect(s) of the present invention, nano-silica particles having hydrophobic functional groups introduced exist in the form of nano-silica aggregates, which are dispersed in the TPU resin in an aggregate state that is difficult to separate. The aggregates preferably have an average aggregate size of 100 to 1200 nm, and more preferably, an average aggregate size of 200 to 500 nm results in very good dispersibility.

When the size of the hydrophobic nano-silica aggregates is an average of 100 nm or more, the dispersion of the nano-silica is well achieved, but when the average exceeds 1200 nm, the thickening effect is reduced. The size of the nano-silica aggregates refers to the length in the long axis direction of the nano-silica aggregates, and can be measured using a transmission electron microscope or the like.

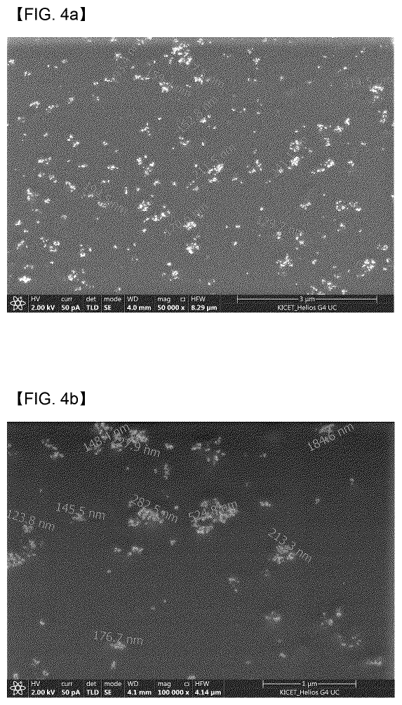

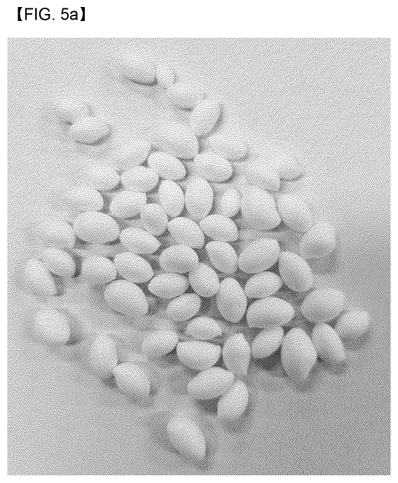

For example, FIGS. 4a and 4b present SEM photographs of the surface of a TPU resin formulated with 1 phr of hydrophobic nano-silica having a primary particle size of about 20 nm and containing dimethyl groups as hydrophobic functional groups on the surface. It was found that the hydrophobic nano-silica powder dispersed in the TPU resin was well dispersed into nano-silica aggregates with a certain size.

For the above reasons, the TPU shoe sole containing hydrophobic nano-silica by supercritical physical foaming manufactured according to an aspect(s) of the present invention has a foaming nuclear agent composed of hydrophobic nano-silica aggregates well dispersed and distributed within the TPU resin, so that fine foam cells are uniformly formed, and thus there is almost no difference in the size of the foam pellets or in the density by region, and in addition to a soft touch and a comfortable fit with high elasticity, it has excellent shape stability and durability, and can realize product weight reduction and material cost reduction.

A method for manufacturing a TPU shoe sole by supercritical physical foaming according to a first embodiment of the present invention may include: injecting a supercritical fluid into a thermoplastic polyurethane resin containing hydrophobic nano-silica as described above at a temperature of 120 to 180° C. to manufacture foam pellets having a specific gravity of 0.05 to 0.25; and then compression-molding the foam pellets to manufacture any one of a shoe insole and a midsole.

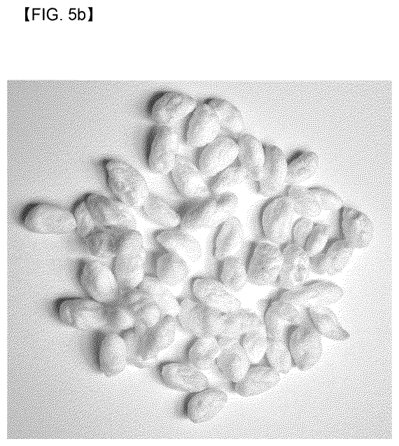

As shown in the photograph in FIG. 5a, the TPU foam pellets manufactured by the first embodiment can be used to manufacture shoe soles with excellent properties such as light weight, elasticity, and tactile feel, as the foam cells (5 to 50 μm in size) are uniformly formed throughout. On the other hand, as shown in the photograph of FIG. 5b, TPU foam pellets not mixed with hydrophobic nano-silica were found to have non-uniform sizes, rough surfaces, and a tendency to clump together, resulting in poor appearance and properties of the manufactured shoe soles.

Furthermore, the method of manufacturing a TPU shoe sole by supercritical physical foaming according to the second embodiment of the present invention is to manufacture an insole and/or a midsole of a shoe by injection molding a TPU resin compounded with hydrophobic nano-silica at a temperature of 160 to 220° C. by injecting a supercritical fluid at a specific gravity within 0.05 to 0.25, as described above.

At this point, the supercritical fluid is characterized by the injection of one or more gases selected from carbon dioxide (CO₂) and nitrogen (N₂) at temperatures and pressures above the critical point. The supercritical fluid has both gaseous and liquid properties, combining the diffusivity of a gas with the solubility of a liquid, and possesses the advantages of being odorless, non-toxic, and non-flammable. Once it exceeds a specific temperature (critical temperature) and pressure (critical pressure), its state remains unchanged regardless of the amount of heat or pressure applied. Accordingly, carbon dioxide is easier to convert into a supercritical state than other substances due to its low critical temperature and critical pressure. It is chemically stable and non-corrosive, can be used as a solvent to replace organic solvents, and is environmentally friendly as it is non-toxic. As mentioned above, carbon dioxide has a critical point of 31° C. and 7.38 MPa, and becomes a supercritical fluid at temperatures and pressures above these values. For example, at 100° C. and 100 MPa, carbon dioxide forms a supercritical fluid.

And in the third embodiment of the present invention, an autoclave process is applied as a supercritical physical foaming process, and the manufacturing process of a TPU shoe sole thereby is as follows. First, as mentioned above, a thermoplastic polyurethane resin mixed with hydrophobic nano-silica is injection-molded into a preform using a conventional injection molding machine, and then a supercritical fluid is injected or input into the preform at a temperature of 120 to 220° C. to foam it to produce a foamed product having a specific gravity of 0.05 to 0.15, and then this is compression-molded again to produce one of a lightweight, highly elastic shoe insole and midsole having a final specific gravity of 0.07 to 0.17.

In this way, in the present invention, by introducing hydrophobic nano-silica through autoclave supercritical physical foaming, uniformity of foaming quality and molding precision can be secured simultaneously, and in particular, it is very advantageous in controlling the foaming rate and securing physical properties when manufacturing a TPU molded body with high hardness (e.g., 90 A or more).

Herein after, the method for manufacturing a TPU shoe sole (midsole/insole) containing hydrophobic nano-silica by supercritical physical foaming according to the present invention will be specifically examined, but the present invention will be explained through preferred examples that can be easily carried out by a person having ordinary skilled in the technical field to which the present invention belongs.

### Embodiment 1

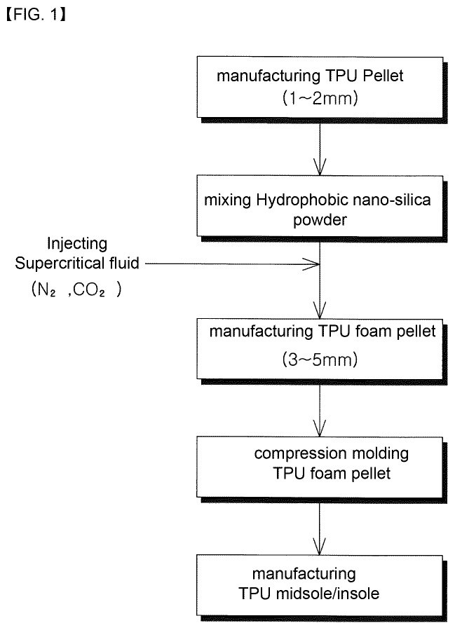

FIG. 1 is a flow chart showing a method for manufacturing a TPU shoe sole mixed with hydrophobic nano-silica by supercritical physical foaming according to a preferred first embodiment of the present invention.

Referring to the FIG. 1, the method for manufacturing a shoe sole according to the first embodiment of the present invention first mixes polyol, isocyanate, a chain extender, and an additive as raw materials, and polymerizes the same to manufacture thermoplastic polyurethane resin chips (TPU pellets) having a size of 1 to 2 mm, and then mixes hydrophobic nano-silica powder having a primary particle size of 1 to 100 nm as a foaming nucleus in an amount of 0.1 to 5 phr. At this time, according to an aspect(s) of the present invention, the hydrophobic nano-silica powder is mixed into the TPU pellets manufactured by the polymerization reaction, but the TPU pellets can be manufactured by mixing the hydrophobic nano-silica powder during the polymerization reaction or when mixing the raw materials.

Thereafter, N₂ and CO₂ as supercritical fluids were mixed and injected at a temperature of 100 to 180° C. and a pressure of 70 to 150 atm into the thermoplastic polyurethane resin mixed with the hydrophobic nano-silica powder to produce foam pellets having an average particle size of 3 to 5 mm and a specific gravity of 0.05 to 0.25. Next, the foam pellets were compression molded to produce TPU midsole/insole.

On the other hand, the present invention utilizes a chest molding process as a compression molding process. The chest molding process is a process in which the foam pellets are injected into the mold after closing the mold consisting of upper and lower parts, and steam is applied at a temperature of 110˜150° C. to partially melt the surface of the foam pellets and fuse them together. The steam pressure injected into the mold is preferably in the range of 10 to 100 atmospheric pressure (ATM), and is sufficiently pressed for 1 to 7 minutes so that the surface of the foam pellets can be melted and fused. At this time, if the temperature, the pressure, and the time are insufficient, the adhesion between the foam pellets is not good and the foam pellets easily fall off, causing durability problems, and if the temperature, pressure, and time are excessive, excessive melting occurs, causing the foam to collapse and poor appearance.

### Embodiment 2

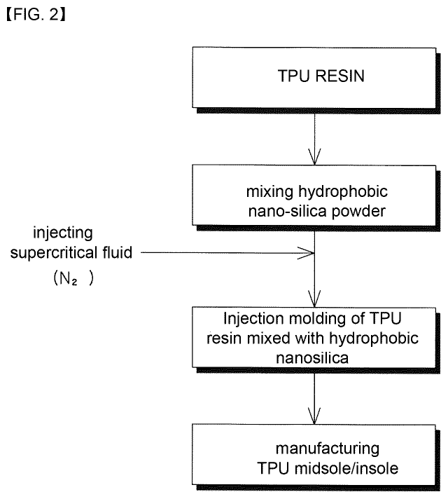

FIG. 2 is a flow chart showing a method for manufacturing a TPU shoe sole mixed with hydrophobic nano-silica by supercritical physical foaming according to a preferred second embodiment of the present invention.

Referring to FIG. 2, the method for manufacturing a shoe sole according to the second embodiment of the present invention comprises: first, polyols, isocyanates, chain extenders, and additives were mixed as raw materials, and then polymerized to produce TPU resin and the TPU resin is then mixed with hydrophobic nano-silica powder, which serves as a foaming agent, in an amount of 0.1 to 5 phr, where the primary particle size of the nano-silica powder is 1 to 100 nm. Hydrophobic nano-silica powder is mixed with TPU pellets produced by polymerization according to an aspect(s) of the present invention, but it is also possible to mix hydrophobic nano-silica powder during polymerization or when mixing raw materials to produce TPU pellets.

Afterwards, the TPU resin mixed with the hydrophobic nano-silica powder was melted at a temperature of 160 to 220° C. and N₂ in a supercritical fluid state was injected alone to manufacture a TPU midsole/insole by injection molding at a specific gravity of 0.05 to 0.25.

At this time, if the temperature of the molten TPU resin is low, the supercritical fluid does not melt sufficiently, resulting in uneven foaming, and if the temperature is too high, the resin may carbonize or generate large bubbles. In addition, uneven foaming and formation of large bubbles may cause uneven quality, and large differences in density and hardness may occur depending on the measurement area. In severe cases, this may also affect the appearance of the product.

### Embodiment 3

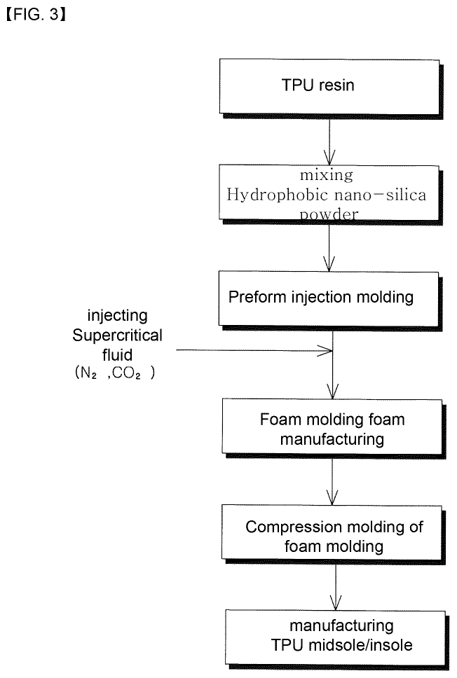

FIG. 3 is a flow chart showing a method for manufacturing a TPU shoe sole mixed with hydrophobic nano-silica by supercritical physical foaming using an autoclave process according to a third embodiment of the present invention.

Referring to the above FIG. 3, the method for manufacturing a shoe sole according to the third embodiment of the present invention first may include, mixing polyol, isocyanate, a chain extender, and an additive as raw materials, and polymerizing the same to manufacture a thermoplastic polyurethane resin, and then mixing hydrophobic nano-silica powder having a primary particle size of 1 to 100 nm as a foaming nuclear agent in an amount of 0.1 to 5 phr. At this time, according to an aspect(s) of the present invention, the hydrophobic nano-silica powder is mixed into TPU pellets manufactured by a polymerization reaction, but the TPU pellets can be manufactured by mixing the hydrophobic nano-silica powder during the polymerization reaction or when mixing the raw materials.

The TPU resin mixed with the hydrophobic nano-silica powder was then used to manufacture the TPU shoe sole by an autoclave process, i.e., the TPU resin was injection molded into a preform using a conventional injection machine. Then, the preform was formed by injecting N₂ and CO₂ as supercritical fluids at a temperature of 120-220° C. at 100˜350 bar, mixed or alone, to produce a foam mold with a specific gravity of 0.05-0.15, and then the foam mold was compression molded at 50-150 atmospheres and a temperature of 140-180° C. for 3-7 minutes to produce a TPU midsole/insole with a specific gravity of 0.07-0.17.

At this time, the compression molding conditions vary depending on the material used and the design of the final product, and the pressure must be such that the foam molding foam can be completely extruded into the mold according to the compression ratio. A design with a high compression ratio requires higher pressure, and a design with a low compression ratio uses relatively low pressure. The molding temperature and time are also related to the design and density of the final product, and if the temperature and time are insufficient, it causes insufficient density due to non-molding and poor size (thickness, width, length). Excessive temperature and time result in poor appearance due to over-melting of the final product surface and poor density due to loss of foam structure.

Meanwhile, the above-described embodiment of the present invention proposes using supercritical fluids CO₂ and N₂ mixed or alone. Since the CO₂ and N₂ have different chemical properties, they are used differently depending on the polymer material used for foaming. CO₂ has a molecular structure with relatively greater polarity than N₂ due to oxygen atoms. This is a property that is advantageous for compatibility with TPU materials with relatively greater polarity, and plays a role in dissolving and softening the TPU material during the supercritical foaming process.

On the other hand, N₂ has low polarity and thus has poor compatibility with the TPU. However, this characteristic greatly contributes to the formation of microbubbles in which N₂ dispersed in the material acts as a nucleus in the foaming stage. That is, CO₂ first makes the TPU soft, and then N₂, which has low solubility, penetrates and acts as a nucleus. Specifically, in the low-pressure supercritical foaming process of 100 atm, CO₂ first dissolves in the TPU, and the TPU becomes very soft, and when N₂, which has low solubility, is injected in the next stage, it can be easily dispersed and entered. Afterwards, in the reduced-pressure foaming stage, N₂ acts as a nucleus, causing foaming.

On the other hand, according to an aspect(s) of the present invention, only N₂ can be used without using CO₂. Under ultra-high pressure conditions such as 300 atm, sufficient penetration power can be achieved with only N₂ without necessarily using CO₂. The N₂ that has penetrated in this way forms an ultra-fine cell structure during the depressurized foaming process, allowing the production of a foam with excellent physical properties. In particular, since CO₂ is not used, the melting viscosity of the TPU resin is not greatly reduced, allowing the fine cells to be stably maintained.

### Experimental Example

When manufacturing the shoe midsole/insole as in Examples 1, 2, and 3 above, TPU shoe soles (Examples (1) to 4) according to the proportion of hydrophobic nano-silica powder included in the thermoplastic polyurethane resin were tested by comparing the TPU shoe sole containing 10 phr of hydrophobic nano-silica powder (Example 5)) with the TPU shoe sole not containing hydrophobic nano-silica powder (Example 6) as a comparison example. The average values of the results of multiple evaluations of moldability, appearance, and elasticity are shown in Table 1 below (⊚: very good, ∘: good, Δ: moderate, x: poor).

TABLE 1

| | Produc- | Produc- | Produc- | Produc- | Produc- | Produc- |
|---|---|---|---|---|---|---|
| | tion | tion | tion | tion | tion | tion |
| | Example | Example | Example | Example | Example | Example |
| category | \textcircled{1} | \textcircled{2} | \textcircled{3} | \textcircled{4} | \textcircled{5} | \textcircled{6} |
| Hydrophobic | 0.1 | 1 | 3 | 5 | 10 | 0 |
| N.S. Powder | | | | | | |
| (phr) | | | | | | |
| Formability | ∘ | ⊚ | ⊚ | ∘ | Δ | x |
| and | | | | | | |
| appearance | | | | | | |
| condition | | | | | | |
| elasticity | ∘ | ⊚ | ⊚ | ∘ | Δ | ∘ |

As shown in the above [Table 1], when comparing the experimental results for the TPU shoe soles of Manufacturing Examples \textcircled{1} to \textcircled{4} manufactured according to Examples 1 to 3 and Manufacturing Examples \textcircled{5} to \textcircled{6} manufactured in the same manner, it was found that Manufacturing Examples \textcircled{1} to \textcircled{4} manufactured according to the present invention had good moldability and appearance, and excellent touch and elasticity overall. On the other hand, in the case of Manufacturing Example \textcircled{5} where the content of hydrophobic nano-silica powder exceeded 5 phr, uniform foam cells were not formed, so the moldability and appearance were not smooth and the elasticity was uneven. In addition, it was confirmed that Manufacturing Example \textcircled{6} that did not contain hydrophobic nano-silica powder had good elasticity but poor moldability and appearance, so there was a possibility that the productivity and dimensional stability of the product would be reduced.

As described above, according to the present invention, by including hydrophobic nano-silica powder in the range of 0.1 to 5 phr as a foaming nucleus during a TPU shoe sole (midsole/insole) molding process by supercritical physical foaming, fine foam cells are uniformly formed throughout, thereby providing a soft touch and a comfortable fit with high elasticity, as well as excellent dimensional stability and durability, and enabling weight reduction of the product and reduction in material costs, thereby significantly improving the quality and productivity of shoes to which it is applied.

Therefore, the method for manufacturing a TPU shoe sole containing hydrophobic nano-silica by supercritical physical foaming according to an aspect(s) of the present invention can be substituted, modified, and changed in various forms without departing from the technical spirit of the present invention, and in particular, has the advantages of being environmentally friendly and reducing the defect rate and material cost in the manufacturing process, and can be applied to various purposes such as various shoe soles requiring uniform moldability, as well as foam packages for shoe insoles or uppers (decoration), molding materials, cushioning materials, and filling materials used in the interior of clothing, bags, sporting goods, household goods, and industrial goods made of fibers, natural and synthetic leather, plastics, etc.

1. A method for manufacturing thermoplastic polyurethane (TPU) shoe soles using TPU resin composed of polyol, isocyanate, and chain extender as raw materials, wherein the TPU resin contains hydrophobic nano-silica powder with primary particle sizes of 1 to 100 nm as a foaming nuclear agent in a range of 0.1 to 5 parts per hundred resin (phr), the hydrophobic nano-silica powder forms nano-silica aggregates with an average size of 100 to 1,200 nm within the thermoplastic polyurethane resin, the method comprising:
foaming a pellet by supercritical physical foaming by injecting a supercritical fluid into the TPU resin,
under a temperature in a range of 120 to 180° C. to produce a foamed pellet with a specific gravity of 0.05 to 0.25; and
compress-molding the foamed pellets, thereby producing a TPU shoe sole comprising hydrophobic nano-silica.

2. A method for manufacturing thermoplastic polyurethane (TPU) shoe soles using TPU resin composed of polyol, isocyanate, and chain extender as raw materials, wherein the TPU resin comprises hydrophobic nano-silica powder with primary particle sizes of 1 to 100 nm as a foaming nuclear agent in a range of 0.1 to 5 parts per hundred resin (phr), the hydrophobic nano-silica powder forms nano-silica aggregates with an average size of 100 to 1,200 nm in the TPU resin, the method comprising:
injecting a supercritical fluid into the TPU resin, by supercritical physical foaming, at a temperature of 160 to 220° C. for injection molding at a specific gravity in a range of 0.05 to 0.25, thereby forming TPU shoe sole with hydrophobic nano-silica.

3. A method for thermoplastic polyurethane (TPU) shoe soles using TPU resin composed of polyol, isocyanate, and chain extender as raw materials, wherein the TPU resin comprises hydrophobic nano-silica powder with primary particle sizes of 1 to 100 nm as a foaming nuclear agent in a range of 0.1 to 5 parts per hundred resin (phr), the hydrophobic nano-silica powder forms nano-silica aggregates with an average size in a range of 100 to 1,200 nm in the thermoplastic polyurethane resin, the method comprising:
injection molding the TPU resin to form a preform; and
injecting a supercritical fluid into the preform, by supercritical physical foaming, at a temperature in a range of 120 to 220° C., to produce a foamed molded foam with a specific gravity in a range of 0.05 to 0.15, thereby producing a TPU shoe sole comprising hydrophobic nano-silica.

4. The method for thermoplastic polyurethane (TPU) shoe soles of claim 1,
wherein the hydrophobic nano-silica powder comprises one or more hydrophobic functional groups, the functional group selected from the group consisting of alkyl groups, dimethyl groups, trimethyl groups, dimethylsiloxane groups, and methacryl groups on the surface of the nano-silica particles.

5. The method for thermoplastic polyurethane (TPU) shoe soles of claim 2,
wherein the hydrophobic nano-silica powder comprises one or more hydrophobic functional groups, the functional group selected from the group consisting of alkyl groups, dimethyl groups, trimethyl groups, dimethylsiloxane groups, and methacryl groups on the surface of the nano-silica particles.

6. The method for thermoplastic polyurethane (TPU) shoe soles of claim 3,
wherein the hydrophobic nano-silica powder comprises one or more hydrophobic functional groups, the functional group selected from the group consisting of alkyl groups, dimethyl groups, trimethyl groups, dimethylsiloxane groups, and methacryl groups on the surface of the nano-silica particles.

7. The method for thermoplastic polyurethane (TPU) shoe soles of claim 1,
wherein injecting the supercritical fluid at a temperature and pressure above the critical point, wherein the supercritical fluid is at least one gas selected from the group consisting of carbon dioxide (CO₂) and nitrogen (N₂).

8. The method for thermoplastic polyurethane (TPU) shoe soles of claim 2,
wherein injecting the supercritical fluid at a temperature and pressure above the critical point, wherein the supercritical fluid is at least one gas selected from the group consisting of carbon dioxide (CO₂) and nitrogen (N₂).

9. The method for thermoplastic polyurethane (TPU) shoe soles of claim 3,
wherein injecting the supercritical fluid at a temperature and pressure above the critical point, wherein the supercritical fluid is at least one gas selected from the group consisting of carbon dioxide (CO₂) and nitrogen (N₂).

10. The method for thermoplastic polyurethane (TPU) shoe soles of claim 1,
wherein the TPU shoe sole is any one of shoe insole or shoe midsole.

11. The method for thermoplastic polyurethane (TPU) shoe soles of claim 2,
wherein the TPU shoe sole is any one of shoe insole or shoe midsole.

12. The method for thermoplastic polyurethane (TPU) shoe soles of claim 3,
wherein the TPU shoe sole is any one of shoe insole or shoe midsole.

13. The method for thermoplastic polyurethane (TPU) shoe soles of claim 3,
wherein the foamed molded foam is compression molded with a specific gravity in a range of 0.07 to 0.17.
